(19) United States
(12) Patent Application Publication
(10) Pub. No.: US 2009/0012723 A1
(43) Pub. Date: Jan. 8, 2009

(54) Adaptive Method for Outlier Detection and Spectral Library Augmentation

(75) Inventors: Patrick J. TREADO, Pittsburgh, PA (US); Robert Schweitzer, Pittsburgh, PA (US); Jason Neiss, Pittsburgh, PA (US)

Correspondence Address: CHEMIMAGE CORPORATION, 7301 PENN AVENUE, PITTSBURGH, PA, 15208, US

(73) Assignee: Chemlmage Corporation, Pittsburgh, PA (US)

(21) Appl. No.: 12/196,921

(22) Filed: Aug. 22, 2008

Related U.S. Application Data
(63) Continuation-in-part of application No. 11/450,138, filed on Jun. 9, 2006.
(60) Provisional application No. 60/688,812, filed on Jun. 9, 2005.
(60) Provisional application No. 60/711,593, filed on Aug. 26, 2005.
(60) Provisional application No. 60/957,757, filed on Aug. 24, 2007.

(51) Int. Cl. G01N 31/00; G06F 19/00

(52) U.S. Cl. 702/28; 702/22

(57) ABSTRACT

A method for analyzing data from an unknown substance, whereby target data representative of an unknown substance is received and compared to reference data associated with one or more known substances. Such comparison determines one or more candidate substances. After determining candidate substances, it is determined if the target data is unique to a candidate substance. If the target data is unique to one of the candidate substances, then this determination is confirmed with fusion. If the target data is not unique, then the target data may be subjected to fusion and unmixing with fusion. If analysis of the target data determines that an outlier is present, then this target data is added to a pool of unassigned data. The addition of this new data to the pool of unassigned data may result in clustering of enough of the previously unassigned data to form a new candidate class. If analysis of the target data does not detect an outlier, but cannot be matched to an existing candidate class, the target data in this case can also be added to the pool of unassigned data. If no outlier is detected, and the Matching Existing Class step is successful, then the target data is added to the matched class. If this candidate class is confirmed, then it can be added to the list of existing classes.

### RELATED APPLICATIONS

This application is a continuation-in-part of pending U.S. patent application Ser. No. 11/450,138, titled “Forensic Integrated Search Technology” and filed on Jun. 9, 2006, which, in turn, claims the priority benefits of U.S. Provisional Application No. 60/688,812, filed on Jun. 9, 2005 and titled, “Forensic Integrated Search Technology,” and U.S. Provisional Application No. 60/711,593, filed on Aug. 26, 2005 and titled “Forensic Integrated Search Technology.” The disclosures of all of these applications are incorporated herein by reference in their entireties. This application further claims priority benefit under 35 U.S.C. § 119(e) of the U.S. Provisional Application No. 60/957,757.

### FIELD OF DISCLOSURE

This application relates generally to systems and methods for searching spectral data bases and identifying unknown materials. More particularly, this application relates to outlier detection and spectral library augmentation.

### BACKGROUND

The challenge of integrating multiple data types into a comprehensive database searching algorithm has yet to be adequately solved. Existing data fusion and database searching algorithms used in the spectroscopic community suffer from key disadvantages. Most notably, competing methods such as interactive searching are not scalable, and are at best semi-automated, requiring significant user interaction. For instance, the BioRAD KnowItAll® software claims an interactive searching approach that supports searching up to three different types of spectral data using the search strategy most appropriate to each data type. Results are displayed in a scatter plot format, requiring visual interpretation and restricting the scalability of the technique. Also, this method does not account for mixture component searches. Data Fusion Then Search (DFTS) is an automated approach that combines the data from all sources into a derived feature vector and then performs a search on that combined data. The data is typically transformed using a multivariate data reduction technique, such as Principal Component Analysis, to eliminate redundancy across data and to accentuate the meaningful features. This technique is also susceptible to poor results for mixtures, and it has limited capacity for user control of weighting factors.

The present disclosure describes a system and method that overcomes these disadvantages allowing users to identify unknown materials with multiple spectroscopic data.

### SUMMARY

The present disclosure generally relates to spectral analysis and provides for a system and method to search spectral databases and to identify unknown materials. In one embodiment, the disclosure relates to the detection of spectral “outliers.” In another embodiment, the disclosure relates to an adaptive methodology for spectral library augmentation. In spectral analysis, certain spectral data may be classified as “outliers” from a library of reference spectral data sets. Broadly speaking, the term “outlier” may refer to any spectral data set that is not present in a relevant library. For example, in a library or set of reference Raman spectra of known biological threat agents, a target Raman spectral data set or spectrum (e.g., from a perceived biological threat) may be considered as an “outlier” when that spectrum is found not to match with any spectrum in the reference library. However, a simplistic interpretation of the term “outlier” may not be reliable for sensitive and specific detection of hazardous materials including chemical, biological, radiological, nuclear, and explosive (CBRNE) materials. It is noted here that an “outlier” may represent the actual target data or may just include noise. Therefore, additional analysis of initial outlier status determination may be necessary to accurately determine whether the target data set is a true outlier.

The present disclosure provides a detailed discussion of analysis of spectral data collected from a target (or sample under investigation) so as to more clearly define outlier datasets and, in turn, augment existing spectral libraries to adaptively accommodate such outlier datasets to allow for improved detection in the field of previously undetectable or unknown compounds. The discussion below relates to a more accurate identification or detection of outliers among target spectral data sets and to a methodology to determine when an outlier may be added to the reference library data set. The process outlined may be automated so as to accomplish outlier detection and classification without user intervention. Alternatively, a portion of the process may be performed in software and another portion may be performed manually.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 illustrates an exemplary system of the present disclosure;

FIG. 2 illustrates an exemplary method of the present disclosure;

FIG. 3 illustrates another exemplary method of the present disclosure;

FIG. 4 illustrates another exemplary method of the present disclosure;

FIG. 5A illustrates an exemplary flowchart of the present disclosure;

FIG. 5B illustrates an exemplary flowchart for a method of the present disclosure;

FIG. 5C illustrates an exemplary flowchart for a method of the present disclosure;

FIG. 6 illustrates an exemplary notional region of two noise-degraded classes.

FIG. 7 illustrates an exemplary situation wherein possible classes may overlap for a small subspace in n-dimensional space.

FIG. 8 illustrates an example of reclassification of data using the adaptive learning of a method of the present disclosure.

FIG. 9A illustrates an exemplary set of test results according to one embodiment of the present disclosure.

FIG. 9B illustrates an exemplary set of test results according to one embodiment of the present disclosure.

FIG. 9C illustrates an exemplary set of test results according to one embodiment of the present disclosure.

FIG. 9D illustrates an exemplary set of test results according to one embodiment of the present disclosure.

### DESCRIPTION OF THE EMBODIMENTS

Reference will now be made in detail to the embodiments of the present disclosure, examples of which are illustrated in the accompanying drawings. Wherever possible, the same reference numbers will be used throughout the drawings to refer to the same or like parts.

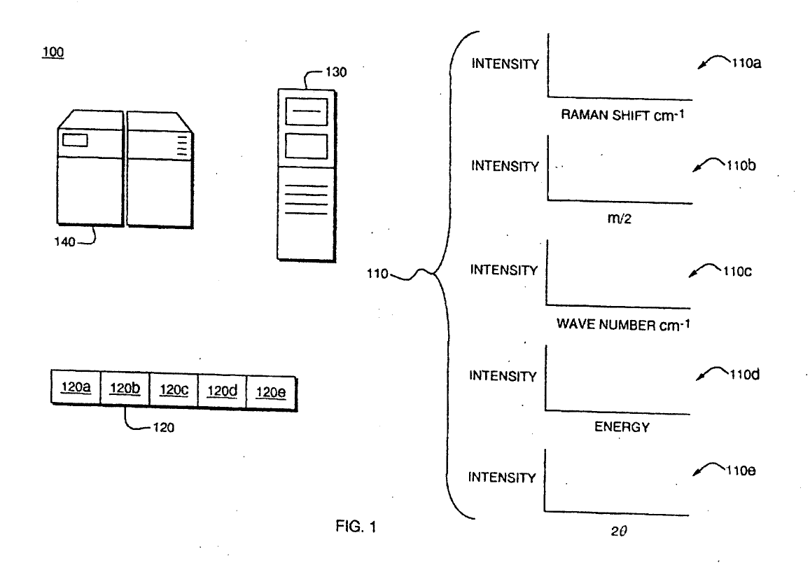

FIG. 1 illustrates an exemplary system 100 which may be used to carry out the methods of the present disclosure. System 1 includes a plurality of test data sets 110, a library 120, at least one processor 130 and a plurality of spectroscopic data generating instruments 140. The plurality of test data sets 110 includes data that are characteristic of an unknown material. The composition of the unknown material includes a single chemical composition or a mixture of chemical compositions.

The plurality of test data sets 110 includes data that characterizes an unknown material. The plurality of test data sets 110 are obtained from a variety of instruments 140 that produce data representative of the chemical and physical properties of the unknown material. The plurality of test data sets includes spectroscopic data, text descriptions, chemical and physical property data, and chromatographic data. In one embodiment, the plurality of test data sets includes a spectrum or a pattern that characterizes the chemical composition, molecular composition, physical properties and/or elemental composition of an unknown material. In another embodiment, the plurality of test data sets includes one or more of a Raman spectrum, a mid-infrared spectrum, an x-ray diffraction pattern, an energy dispersive x-ray spectrum, and a mass spectrum that are characteristic of the unknown material. In yet another embodiment, the plurality of test data sets may also include an image data set of the unknown material. In still another embodiment, the test data set may include a physical property test data set selected from the group consisting of boiling point, melting point, density, freezing point, solubility, refractive index, specific gravity or molecular weight of the unknown material. In another embodiment, the test data set includes a textual description of the unknown material.

The plurality of spectroscopic data generating instruments 140 include any analytical instrument which generates a spectrum, an image, a chromatogram, a physical measurement and a pattern characteristic of the physical properties, the chemical composition, or structural composition of a material. In one embodiment, the plurality of spectroscopic data generating instruments 140 includes a Raman spectrometer, a mid-infrared spectrometer, an x-ray diffractometer, an energy dispersive x-ray analyzer and a mass spectrometer. In another embodiment, the plurality of spectroscopic data generating instruments 140 further includes a microscope or image generating instrument. In yet another embodiment, the plurality of spectroscopic generating instruments 140 further includes a chromatographic analyzer.

Library 120 includes a plurality of sublibraries 120a, 120b, 120c, 120d and 120e. Each sublibrary is associated with a different spectroscopic data generating instrument 140. In one embodiment, the sublibraries include a Raman sublibrary, a mid-infrared sublibrary, an x-ray diffraction sublibrary, an energy dispersive sublibrary and a mass spectrum sublibrary. For this embodiment, the associated spectroscopic data generating instruments 140 include a Raman spectrometer, a mid-infrared spectrometer, an x-ray diffractometer, an energy dispersive x-ray analyzer and a mass spectrometer. In another embodiment, the sublibraries further include an image sublibrary associated with a microscope. In yet another embodiment, the sublibraries further include a textual description sublibrary. In still yet another embodiment, the sublibraries further include a physical property sublibrary.

Each sublibrary contains a plurality of reference data sets. The plurality of reference data sets includes data representative of the chemical and physical properties of a plurality of known materials. The plurality of reference data sets includes spectroscopic data, text descriptions, chemical and physical property data, and chromatographic data. In one embodiment, a reference data set includes a spectrum and a pattern that characterizes the chemical composition, the molecular composition and/or element composition of a known material. In another embodiment, the reference data set includes a Raman spectrum, a mid-infrared spectrum, an x-ray diffraction pattern, an energy dispersive x-ray spectrum, and a mass spectrum of known materials. In yet another embodiment, the reference data set further includes a physical property test data set of known materials selected from the group consisting of boiling point, melting point, density, freezing point, solubility, refractive index, specific gravity or molecular weight. In still another embodiment, the reference data set further includes an image displaying the shape, size and morphology of known materials. In another embodiment, the reference data set includes feature data having information such as particle size, color and morphology of the known material.

System 100 further includes at least one processor 130 in communication with the library 120 and sublibraries. The processor 130 executes a set of instructions to identify the composition of an unknown material.

In one embodiment, system 100 includes a library 120 having the following sublibraries: a Raman sublibrary associated with a Raman spectrometer; an infrared sublibrary associated with an infrared spectrometer; an x-ray diffraction sublibrary associated with an x-ray diffractometer; an energy dispersive x-ray sublibrary associated with an energy dispersive x-ray spectrometer; and a mass spectrum sublibrary associated with a mass spectrometer. The Raman sublibrary contains a plurality of Raman spectra characteristic of a plurality of known materials. The infrared sublibrary contains a plurality of infrared spectra characteristic of a plurality of known materials. The x-ray diffraction sublibrary contains a plurality of x-ray diffraction patterns characteristic of a plurality of known materials. The energy dispersive sublibrary contains a plurality of energy dispersive spectra characteristic of a plurality of known materials. The mass spectrum sublibrary contains a plurality of mass spectra characteristic of a plurality of known materials. The test data sets include two or more of the following: a Raman spectrum of the unknown material, an infrared spectrum of the unknown material, an x-ray diffraction pattern of the unknown material, an energy dispersive spectrum of the unknown material, and a mass spectrum of the unknown material.

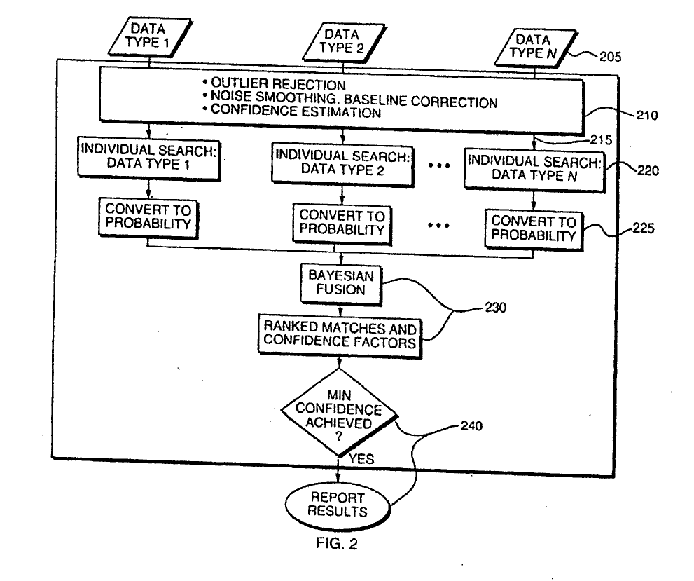

With reference to FIG. 2, a method of the present disclosure is illustrated to determine the identification of an unknown material. In step 205, a plurality of test data sets characteristic of an unknown material are obtained by at least one of the different spectroscopic data generating instruments. In one embodiment, the plurality of test data sets 110 are obtained from one or more of the different spectroscopic data generating instruments 140. When a single spectroscopic data generating instrument is used to generate the test data sets, at least two or more test data sets are required. In yet another embodiment, the plurality of test data sets 110 are obtained from at least two different spectroscopic data generating instruments.

In step 210, the test data sets are corrected to remove signals and information that are not due to the chemical composition of the unknown material. Algorithms known to those skilled in the art may be applied to the data sets to remove electronic noise and to correct the baseline of the test data set. The data sets may also be corrected to reject outlier data sets. In one embodiment, the system detects test data sets, having signals and information that are not due to the chemical composition of the unknown material. These signals and information are then removed from the test data sets. In another embodiment, the user is issued a warning when the system detects test data set having signals and information that are not due to the chemical composition of the unknown material.

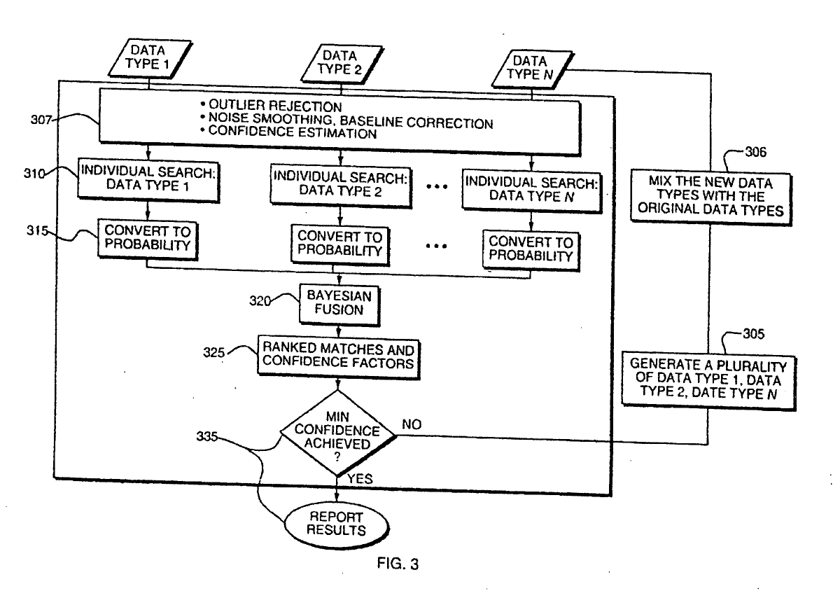

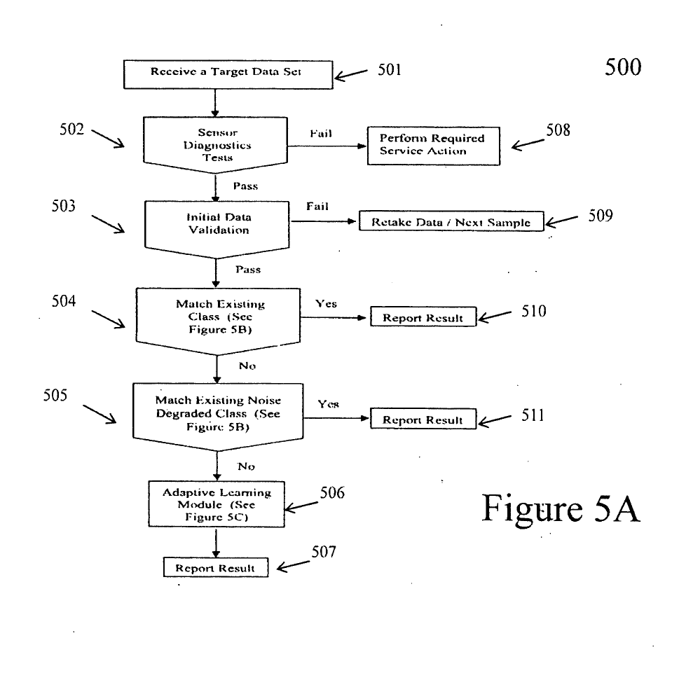

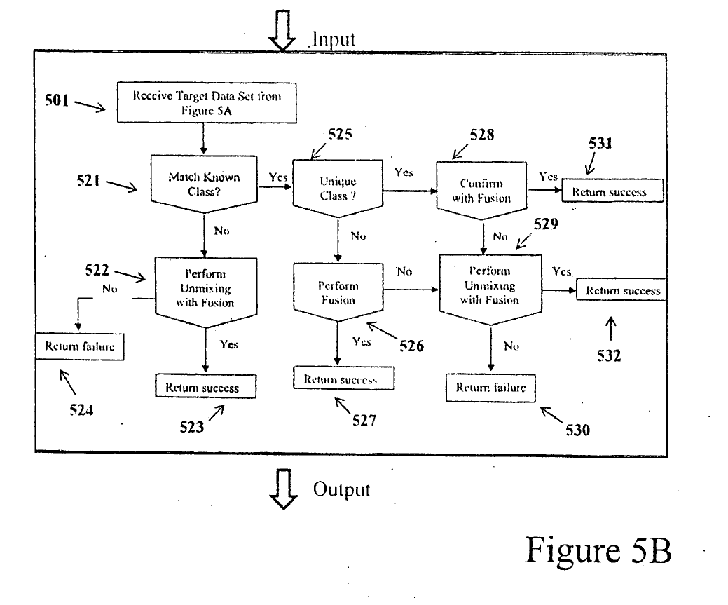

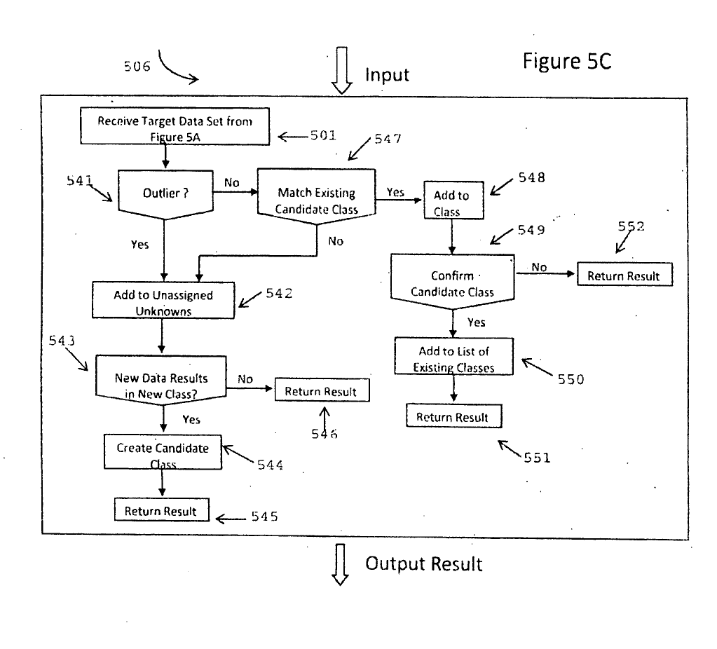

A detailed discussion of the detection of outliers and augmentation of a spectral library is provided hereinbelow with reference to FIGS. 5 through 9 according to one embodiment of the present disclosure. The detected outliers may be rejected as indicated at step 210 in FIG. 2 (or at step 307 in FIG. 3).

With further reference to FIG. 2, each sublibrary is searched, in step 220. The searched sublibraries are those that are associated with the spectroscopic data generating instrument used to generate the test data sets. For example, when the plurality of test data sets includes a Raman spectrum of the unknown material and an infrared spectrum of the unknown material, the system searches the Raman sublibrary and the infrared sublibrary. The sublibrary search is performed using a similarity metric that compares the test data set to each of the reference data sets in each of the searched sublibraries. In one embodiment, any similarity metric that produces a likelihood score may be used to perform the search. In another embodiment, the similarity metric includes one or more of an Euclidean distance metric, a spectral angle mapper metric, a spectral information divergence metric, and a Mahalanobis distance metric. The search results produce a corresponding set of scores for each searched sublibrary. The set of scores contains a plurality of scores, one score for each reference data set in the searched sublibrary. Each score in the set of scores indicates a likelihood of a match between the test data set and each of reference data set in the searched sublibrary.

In step 225, the set of scores, produced in step 220, are converted to a set of relative probability values. The set of relative probability values contains a plurality of relative probability values, one relative probability value for each reference data set.

Referring still to FIG. 2, all relative probability values for each searched sublibrary are fused, in step 230, using the Bayes probability rule. The fusion produces a set of final probability values. The set of final probability values contains a plurality of final probability values, one for each known material in the library. The set of final probability values is used to determine whether the unknown material is represented by a known material in the library.

In step 240, the identity of the unknown material is reported. To determine the identity of the unknown, the highest final probability value from the set of final probability values is selected. This highest final probability value is then compared to a minimum confidence value. If the highest final probability value is greater than or equal to the minimum confidence value, the known material having the highest final probability value is reported. In one embodiment, the minimum confidence value may range from 0.70 to 0.95. In another embodiment, the minimum confidence value ranges from 0.8 to 0.95. In yet another embodiment, the minimum confidence value ranges from 0.90 to 0.95.

As described above, the library 120 contains several different types of sublibraries, each of which is associated with an analytical technique, i.e., the spectroscopic data generating instrument 140. Therefore, each analytical technique provides an independent contribution to identifying the unknown material. Additionally, each analytical technique has a different level of specificity for matching a test data set for an unknown material with a reference data set for a known material. For example, a Raman spectrum generally has higher discriminatory power than a fluorescence spectrum and is thus considered more specific for the identification of an unknown material. The greater discriminatory power of Raman spectroscopy manifests itself as a higher likelihood for matching any given spectrum using Raman spectroscopy than using fluorescence spectroscopy. The method illustrated in FIG. 2 accounts for this variability in discriminatory power in the set of scores for each spectroscopic data generating instrument. The set of scores act as implicit weighting factors that bias the scores according to the discriminatory power of the instrument. While the set of scores act as implicit weighting factors, the method of the present disclosure also provides for using explicit weighting factors. In one embodiment, the explicit weighting factor for each spectroscopic data generating instrument is the same. In another embodiment the weighting factors include {W}={W_{Raman}, W_{x-ray}, W_{MassSpec}, W_{IR}, and W_{ED}}.

In yet another embodiment, each spectroscopic data generating instrument has a different associated weighting factor. Estimates of these associated weighting factors are determined through automated simulations. In particular, with at least two data records for each spectroscopic data generating instrument (i.e. two Raman spectra per material), the library is split into training and validation sets. The training set is then used as the reference data set. The validation set is used as test data set and searched against the training set. Without the weighting factors ({W}={1, 1, . . . , 1}), a certain percentage of the validation set will be correctly identified, and some percentage will be incorrectly identified. By explicitly or randomly varying the weighting factors and recording each set of correct and incorrect identification rates, the optimal operating set of weighting factors, for each spectroscopic data generating instrument, is estimated by choosing those weighting factors that result in the best identification rates.

The method of the present disclosure also provides for using a text query to limit the number of reference data sets of known compounds in the sublibrary searched in step 220 of FIG. 2. The method illustrated in FIG. 2, would further include step 215, where each sublibrary is searched, using a text query. Each known material in the plurality of sublibraries includes a text description of a physical property or a distinguishing feature of the material. A text query, describing the unknown material is submitted. The plurality of sublibraries is searched by comparing the text query to a text description of each of the known materials. A match of the text query to the text description or no match of the text query to the text description is produced. The plurality of sublibraries is modified by removing the reference data sets that produced a no match answer. Therefore, the modified sublibraries have fewer reference data sets than the original sublibraries. For example, a text query for white powders eliminates the reference data sets from the sublibraries for any known compounds having a textual description of black powders. The modified sublibraries are then searched as described for steps 220-240 as illustrated in FIG. 2.

The method of the present disclosure also provides for using images to identify the unknown material. In one embodiment, an image test data set characterizing an unknown material is obtained from an image generating instrument. The test image, of the unknown, is compared to the plurality of reference images for the known materials in an image sublibrary to assist in the identification of the unknown material. In another embodiment, a set of test feature data is extracted from the image test data set using a feature extraction algorithm to generate test feature data. The selection of an extraction algorithm is well known to one of skill in the art of digital imaging. The test feature data includes information concerning particle size, color or morphology of the unknown material. The test feature data is searched against the reference feature data in the image sublibrary, producing a set of scores. The reference feature data includes information such as particle size, color and morphology of the material. The set of scores, from the image sublibrary, are used to calculate a set of probability values. The relative probability values, for the image sublibrary, are fused with the relative probability values for the other plurality of sublibraries as illustrated in FIG. 2, step 230, producing a set of final probability values. The known material represented in the library, having the highest final probability value is reported if the highest final probability value is greater than or equal to the minimum confidence value as in step 240 of FIG. 2.

The method of the present disclosure further provides for enabling a user to view one or more reference data sets of the known material identified as representing the unknown material despite the absence of one or more test data sets. For example, the user inputs an infrared test data set and a Raman test data set to the system. The x-ray dispersive spectroscopy (“EDS”) sublibrary contains an EDS reference data set for the plurality of known compounds even though the user did not input an EDS test data set. Using the steps illustrated in FIG. 2, the system identifies a known material, characterized in the infrared and Raman sublibraries, as having the highest probability of matching the unknown material. The system then enables the user to view an EDS reference data set, from the EDS sublibrary, for the known material having the highest probability of matching the unknown material. In another embodiment, the system enables the user to view one or more EDS reference data sets for one or more known materials having a high probability of matching the unknown material.

The method of the present disclosure also provides for identifying unknowns when one or more of the sublibraries are missing one or more reference data sets. When a sublibrary has fewer reference data sets than the number of known materials characterized within the main library, the system treats this sublibrary as an incomplete sublibrary. To obtain a score for the missing reference data set, the system calculates a mean score based on the set of scores, from step 225, for the incomplete library. The mean score is then used, in the set of scores, as the score for missing reference data set.

The method of the present disclosure also provides for identifying miscalibrated test data sets. When one or more of the test data sets fail to match any reference data set in the searched sublibrary, the system treats the test data set as miscalibrated. The assumed miscalibrated test data sets are processed via a grid optimization process where a range of zero and first order corrections are applied to the data to generate one or more corrected test data sets. The system then reanalyzes the corrected test data set using the steps illustrated in FIG. 2. This same process may be applied during the development of the sublibraries to ensure that all the library spectra are properly calibrated. The sublibrary examination process identifies referenced data sets that do not have any close matches, by applying the steps illustrated in FIG. 2, to determine if changes in the calibration results in close matches.

The method of the present disclosure also provides for the identification of the components of an unknown mixture. With reference to FIG. 2, if the highest final probability value is less than the minimum confidence value, in step 240, the system of the present disclosure treats the unknown as a mixture. Referring to FIG. 3, a plurality of new test data sets, characteristic of the unknown material, are obtained in step 305. Each new test data set is generated by one of the plurality of the different spectroscopic data generating instruments. For each different spectroscopic data generating instruments at least two new test data sets are obtained. In one embodiment, six to twelve new test data sets are obtained from a spectroscopic data generating instrument. The new test data sets are obtained from several different locations of the unknown. The new test data sets are combined with the test data sets, of step 205 in FIG. 2, to generate combined test data sets, of step 306 of FIG. 3. When the test data sets are combined with the new test data sets, the sets must be of the same type in that they are generated by the same spectroscopic data generating instrument. For example, new test data sets generated by a Raman spectrometer are combined with the initial test data sets also generated by a Raman spectrometer.

In step 307, the test data sets are corrected to remove signals and information that are not due to the chemical composition of the unknown material. In step 310, each sublibrary is searched for a match for each combined test data set. The searched sublibraries are associated with the spectroscopic data generating instrument used to generate the combined test data sets. The sublibrary search is performed using a spectral unmixing metric that compares the plurality of combined test data sets to each of the reference data sets in each of the searched sublibraries. A spectral unmixing metric is disclosed in U.S. patent application Ser. No. 10/812,233 entitled “Method for Identifying Components of a Mixture via Spectral Analysis,” filed Mar. 29, 2004 which is incorporated herein by reference in its entirety; however this application forms no part of the present invention. The sublibrary searching produces a corresponding second set of scores for each searched sublibrary. Each second score and the second set of scores is the score and set of scores produced in the second pass of the searching method. Each second score in said second set of scores indicates a second likelihood of a match between the combined test data sets and each of reference data sets in the searched sublibraries. The second set of scores contains a plurality of second scores, one second score for each reference data set in the searched sublibrary.

According to a spectral unmixing metric, the combined test data sets define an n-dimensional data space, where n is the number of points in the test data sets. Principal component analysis (PCA) techniques are applied to the n-dimensional data space to reduce the dimensionality of the data space. The dimensionality reduction step results in the selection of m eigenvectors as coordinate axes in the new data space. For each search sublibrary, the reference data sets are compared to the reduced dimensionality data space generated from the combined test data sets using target factor testing techniques. Each sublibrary reference data set is projected as a vector in the reduced m-dimensional data space. An angle between the sublibrary vector and the data space results from target factor testing. This is performed by calculating the angle between the sublibrary reference data set and the projected sublibrary data. These angles are used as the second scores which are converted to second probability values for each of the reference data sets and fed into the fusion algorithm in the second pass of the search method. This paragraph forms no part of the present invention.

Referring still to FIG. 3, second relative probability values are determined and the values are then fused. A second set of relative probability values are calculated for each searched sublibrary based on the corresponding second set of scores for each searched sublibrary, step 315. The second set of relative probability values is the set of probability values calculated in the second pass of the search method. The second relative probability values for each searched sublibrary are fused using the Bayes probability rule to produce a second set of final probability values, step 320. The set of final probability values are used in determining whether the unknown materials are represented by a set of known materials in the library.

From the set of second final probabilities values, a set of high second final probability values is selected. The set of high second final probability values is then compared to the minimum confidence value, step 325. If each high second final probability value is greater than or equal to the minimum confidence value, step 335, the set of known materials represented in the library having the high second final probability values is the reported. In one embodiment, the minimum confidence value may range from 0.70 to 0.95. In another embodiment, the minimum confidence value may range from 0.8 to 0.95. In yet another embodiment, the minimum confidence value may range from 0.9 to 0.95.

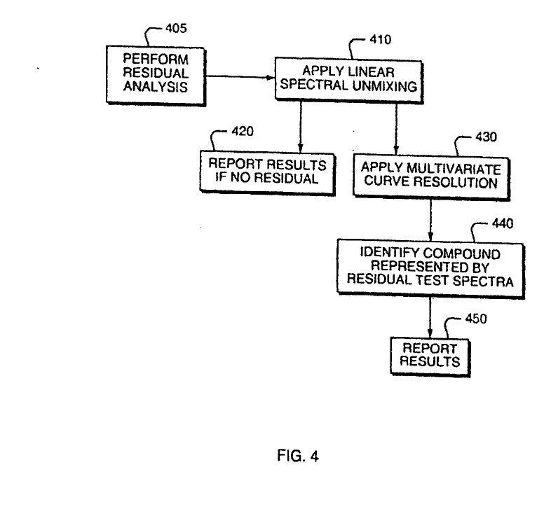

Referring to FIG. 4, a user may also perform a residual analysis 405. For each spectroscopic data generating instrument, residual data is defined by the following equation:

COMBINED TEST DATA SET=CONCENTRATION×REFERENCE DATA SET+RESIDUAL

To calculate a residual data set, a linear spectral unmixing algorithm may be applied to the plurality of combined test data sets, to thereby produce a plurality of residual test data, step 410. Each searched sublibrary has an associated residual test data. When a plurality of residual data are not identified in step 410, a report is issued, step 420. In this step, the components of the unknown material are reported as those components determined in step 335 of FIG. 3. Residual data is determined when there is a significant percentage of variance explained by the residual as compared to the percentage explained by the reference data set defined in the above equation. When residual test data is determined in step 410, a multivariate curve resolution algorithm is applied to the plurality of residual test data generating a plurality of residual data spectra, in step 430. Each searched sublibrary has a plurality of associated residual test spectra. In step 440, the identification of the compound corresponding to the plurality of residual test spectra is determined and reported in step 450. In one embodiment, the plurality of residual test spectra are compared to the reference data set in the sublibrary, associated with the residual test spectra, to determine the compound associated with the residual test spectra. If residual test spectra do not match any reference data sets in the plurality of sublibraries, a report is issued stating an unidentified residual compound is present in the unknown material.

### EXAMPLES

### Example 1

In this example, a network of n spectroscopic instruments each provide test data sets to a central processing unit. Each instrument makes an observation vector {Z} of parameter {X}. For instance, a dispersive Raman spectrum would be modeled with X=dispersive Raman and Z=the spectral data. Each instrument generates a test data set and calculates (using a similarity metric) the likelihoods {pᵢ(Hₐ)} of the test data set being of type Hₐ. Bayes' theorem gives:

$$p ( {H}_{a} \vert \{ Z \} ) = \frac{p ( \{ Z \} \vert {H}_{a} ) p ( {H}_{a} )}{p ( \{ Z \} )} \qquad ( Equation 1 )$$

where:
p(Hₐ({Z}): the posterior probability of the test data being of type Hₐ, given the observations {Z};
p({Z}|Hₐ): the probability that observations {Z} were taken, given that the test data is type Hₐ;
p(Hₐ): the prior probability of type Hₐ being correct; and
p({Z}): a normalization factor to ensure the posterior probabilities sum to 1.
Assuming that each spectroscopic instrument is independent of the other spectroscopic instruments gives:

$$p ( \{ Z \} \vert {H}_{a} ) = {\prod }_{i = 1}^{n} {p}_{i} ( \{ {Z}_{i} \} \vert {H}_{a} ) \qquad ( Equation 2 )$$

and from Bayes rule

$$p ( \{ Z \} \vert {H}_{a} ) = {\prod }_{i = 1}^{n} ( {p}_{i} ( \{ {Z}_{i} \} \vert \{ X \} ) {p}_{i} ( \{ X \} \vert {H}_{a} ) \qquad ( Equation 3 )$$

gives

$$p ( {H}_{a} \vert \{ Z \} ) = α \cdot p ( {H}_{a} ) {\prod }_{i = 1}^{n} [ ( {p}_{i} ( \{ {Z}_{i} \} \vert \{ X \} ) {p}_{i} ( \{ X \} \vert {H}_{a} ) ] \qquad ( Equation 4 )$$

Equation 4 is the central equation that uses Bayesian data fusion to combine observations from different spectroscopic instruments to give probabilities of the presumed identities.

To infer a presumed identity from the above equation, a value of identity is assigned to the test data having the most probable (maximum a posteriori) result:

$${\hat{H}}_{a} = \text{arg} {max}_{a} p ( {H}_{a} \vert \{ Z \} ) \qquad ( Equation 5 )$$

To use the above formulation, the test data is converted to probabilities. In particular, the spectroscopic instrument must give p({Z}|Hₐ), the probability that observations {Z} were taken, given that the test data is type Hₐ. Each sublibrary is a set of reference data sets that match the test data set with certain probabilities. The probabilities of the unknown matching each of the reference data sets must sum to 1. The sublibrary is considered as a probability distribution.

The system applies a few commonly used similarity metrics consistent with the requirements of this algorithm: Euclidean Distance, the Spectral Angle Mapper (SAM), the Spectral Information Divergence (SID), Mahalanobis distance metric and spectral unmixing. The SID has roots in probability theory and is thus the best choice for the use in the data fusion algorithm, although either choice will be technically compatible. Euclidean Distance (“ED”) is used to give the distance between spectrum x and spectrum y:

$$ED ( x , y ) = \sqrt{{\sum }_{i = 1}^{L} {( {x}_{i} - {y}_{i} )}^{2}} \qquad ( Equation 6 )$$

Spectral Angle Mapper (“SAM”) finds the angle between spectrum x and spectrum y:

$$SAM ( x , y ) = {cos}^{- 1} ( \frac{{\sum }_{i = 1}^{L} {x}_{i} {y}_{i}}{\sqrt{{\sum }_{i = 1}^{L} {x}_{i}^{2}} \sqrt{{\sum }_{i = 1}^{L} {y}_{i}^{2}}} ) \qquad ( Equation 7 )$$

When SAM is small, it is nearly the same as ED. Spectral Information Divergence (“SID”) takes an information theory approach to similarity and transforms the x and y spectra into probability distributions p and q:

$$\begin{matrix}p = {[ {p}_{1} , {p}_{2} , … , {p}_{L} ]}^{T} , \\ q = {[ {q}_{1} , {q}_{2} , … , {q}_{L} ]}^{T} \\ {p}_{i} = \frac{{x}_{i}}{{\sum }_{i = 1}^{L} {x}_{i}} , \\ {q}_{i} = \frac{{y}_{i}}{{\sum }_{i = 1}^{L} {y}_{i}}\end{matrix} \qquad ( Equation 8 )$$

The discrepancy in the self-information of each band is defined as:

$${D}_{i} ( {x}_{i} ‖ {y}_{i} ) = log [ \frac{{p}_{i}}{{q}_{i}} ] \qquad ( Equation 9 )$$

So the average discrepancies of x compared to y and y compared to x (which are different) are:

$$D ( x ‖ y ) = {\sum }_{i = 1}^{L} {p}_{i} log [ \frac{{p}_{i}}{{q}_{i}} ] , \\ D ( y ‖ x ) = {\sum }_{i = 1}^{L} {q}_{i} log [ \frac{{q}_{i}}{{p}_{i}} ] , \qquad ( Equation 10 )$$

The SID is thus defined as:

SID(x,y)=D(x∥y)+D(y∥x) (Equation 11)

A measure of the probabilities of matching a test data set with each entry in the sublibrary is needed. Generalizing a similarity metric as m(x, y), the relative spectral discrimination probabilities is determined by comparing a test data set x against k library entries.

$${p}_{x , Library} ( k ) = 1 - \frac{m ( x , {y}_{k} )}{{\sum }_{i = 1}^{L} m ( x , {y}_{i} )} \qquad ( Equation 12 )$$

Equation 12 is used as p({Z}|Hₐ) for each sensor in the fusion formula.

Assuming, a library consists of three reference data sets: {H}={A, B, C}. Three spectroscopic instruments (each a different modality) are applied to this sample and compare the outputs of each spectroscopic instrument to the appropriate sublibraries (i.e. dispersive Raman spectrum compared with library of dispersive Raman spectra). If the individual search results, using SID, are:

SID(x_{Raman},Library_{Raman})={20, 10, 25}

SID(x_{Fluor},Library_{Fluor})={40, 35, 50}

SID(x_{IR},Library_{IR})={50, 20, 40}

Applying Equation 12, the relative probabilities are:

p(Z_{{Raman}}|{H})={0.63, 0.81, 0.55}

p(Z_{{Flour}}|{H})={0.68, 0.72, 0.6}

p(Z_{{IR}}|{H})={0.55, 0.81, 0.63}

It is assumed that each of the reference data sets is equally likely, with:

p({H})={p(H_{A}), p(H_{B}), p(H_{C})}={0.33, 0.33, 0.33}

Applying Equation 4 results in:

p({H}|{Z})=α×{0.33, 0.33, 0.33}×[{0.63, 0.81, 0.55}·{0.68, 0.72, 0.6}·{0.55, 0.81, 0.63}]

p({H}|{Z})=α×{0.0779, 0.1591, 0.0687}

Now normalizing with α=1/(0.0779+0.1591+0.0687) results in:

p({H}|{Z})={0.25, 0.52, 0.22}

The search identifies the unknown sample as reference data set B, with an associated probability of 52%.

### Example 2

Raman and mid-infrared sublibraries each having reference data set for 61 substances were used. For each of the 61 substances, the Raman and mid-infrared sublibraries were searched using the Euclidean distance vector comparison. In other words, each substance is used sequentially as a target vector. The resulting set of scores for each sublibrary were converted to a set of probability values by first converting the score to a Z value and then looking up the probability from a Normal Distribution probability table. The process was repeated for each spectroscopic technique for each substance and the resulting probabilities were calculated. The set of final probability values was obtained by multiplying the two sets of probability values.

The results are displayed in Table 1. Based on the calculated probabilities, the top match (the score with the highest probability) was determined for each spectroscopic technique individually and for the combined probabilities. A value of “1” indicates that the target vector successfully found itself while a value of “0” indicates that the target vector found some match other than itself as the top match. The Raman probabilities resulted in four incorrect results, the mid-infrared probabilities resulted in two incorrect results, and the combined probabilities resulted in no incorrect results.

The more significant result is the fact that the distance between the top match and the second match is significantly large for the combined approach as opposed to Raman or mid-infrared for almost all of the 61 substances. In fact, 15 of the combined results have a difference that is a four times greater distance than the distance for either MIR or Raman, individually. Only five of the 61 substances do not benefit from the fusion algorithm.

| | | | | | Raman | MIR | Combined |
|---|---|---|---|---|---|---|---|
| Index | Substance | Raman | MIR | Combined | Distance | Distance | Distance |
| 1 | 2-Propanol | 1 | 1 | 1 | 0.0429 | 0.0073 | 0.0535 |
| 2 | Acetamidophenol | 1 | 1 | 1 | 0.0406 | 0.0151 | 0.2864 |
| 3 | Acetone | 1 | 1 | 1 | 0.0805 | 0.0130 | 0.2294 |
| 4 | Acetonitrile | 1 | 1 | 1 | 0.0889 | 0.0167 | 0.4087 |
| 5 | Acetylsalicylic Acid | 1 | 1 | 1 | 0.0152 | 0.0152 | 0.0301 |
| 6 | Ammonium Nitrate | 0 | 1 | 1 | 0.0000 | 0.0467 | 0.0683 |
| 7 | Benzalkonium Chloride | 1 | 1 | 1 | 0.0358 | 0.0511 | 0.1070 |
| 8 | Caffeine | 1 | 1 | 1 | 0.0567 | 0.0356 | 0.1852 |
| 9 | Calcium Carbonate | 1 | 1 | 1 | 0.0001 | 0.0046 | 0.0047 |
| 10 | Calcium chloride | 1 | 1 | 1 | 0.0187 | 0.0076 | 0.2716 |
| 11 | Calcium Hydroxide | 1 | 1 | 1 | 0.0009 | 0.0006 | 0.0015 |
| 12 | Calcium Oxide | 1 | 1 | 1 | 0.0016 | 0.0848 | 0.1172 |
| 13 | Calcium Sulfate | 0 | 1 | 1 | 0.0000 | 0.0078 | 0.2818 |
| 14 | Cane Sugar | 1 | 1 | 1 | 0.0133 | 0.0006 | 0.0137 |
| 15 | Charcoal | 1 | 1 | 1 | 0.0474 | 0.0408 | 0.1252 |
| 16 | Cocaine_pure | 1 | 1 | 1 | 0.0791 | 0.0739 | 0.2261 |
| 17 | Creatine | 1 | 1 | 1 | 0.1102 | 0.0331 | 0.3751 |
| 18 | D-Fructose | 1 | 1 | 1 | 0.0708 | 0.0536 | 0.1336 |
| 19 | D-Amphetamine | 1 | 0 | 1 | 0.0400 | 0.0000 | 0.0400 |
| 20 | Dextromethorphan | 1 | 1 | 1 | 0.0269 | 0.1067 | 0.2940 |
| 21 | Dimethyl Sulfoxide | 1 | 1 | 1 | 0.0069 | 0.0466 | 0.1323 |
| 22 | D-Ribose | 1 | 1 | 1 | 0.0550 | 0.0390 | 0.1314 |
| 23 | D-Xylose | 1 | 1 | 1 | 0.0499 | 0.0296 | 0.1193 |
| 24 | Ephedrine | 1 | 1 | 1 | 0.0367 | 0.0567 | 0.2067 |
| 25 | Ethanol_processed | 1 | 1 | 1 | 0.0269 | 0.0276 | 0.1574 |
| 26 | Ethylene Glycol | 1 | 1 | 1 | 0.1020 | 0.0165 | 0.1692 |
| 27 | Ethylenediamine- | 1 | 1 | 1 | 0.0543 | 0.0312 | 0.2108 |
| | tetraacetate | | | | | | |
| 28 | Formula 409 | 1 | 1 | 1 | 0.0237 | 0.0063 | 0.0663 |
| 29 | Glycerol GR | 1 | 1 | 1 | 0.0209 | 0.0257 | 0.1226 |
| 30 | Heroin | 1 | 1 | 1 | 0.0444 | 0.0241 | 0.2367 |
| 31 | Ibuprofen | 1 | 1 | 1 | 0.0716 | 0.0452 | 0.2785 |
| 32 | Ketamine | 1 | 1 | 1 | 0.0753 | 0.0385 | 0.2954 |
| 33 | Lactose Monohydrate | 1 | 1 | 1 | 0.0021 | 0.0081 | 0.0098 |
| 34 | Lactose | 1 | 1 | 1 | 0.0021 | 0.0074 | 0.0092 |
| 35 | L-Amphetamine | 1 | 0 | 1 | 0.0217 | 0.0000 | 0.0217 |
| 36 | Lidocaine | 1 | 1 | 1 | 0.0379 | 0.0418 | 0.3417 |
| 37 | Mannitol | 1 | 1 | 1 | 0.0414 | 0.0361 | 0.0751 |
| 38 | Methanol | 1 | 1 | 1 | 0.0996 | 0.0280 | 0.1683 |
| 39 | Methcathinone-HCl | 1 | 1 | 1 | 0.0267 | 0.0147 | 0.0984 |
| 40 | Para-methoxymethyl- | 1 | 1 | 1 | 0.0521 | 0.0106 | 0.0689 |
| | amphetamine | | | | | | |
| 41 | Phenobarbital | 1 | 1 | 1 | 0.0318 | 0.0573 | 0.1807 |
| 42 | Polyethylene Glycol | 1 | 1 | 1 | 0.0197 | 0.0018 | 0.1700 |
| 43 | Potassium Nitrate | 0 | 1 | 1 | 0.0000 | 0.0029 | 0.0125 |
| 44 | Quinine | 1 | 1 | 1 | 0.0948 | 0.0563 | 0.2145 |
| 45 | Salicylic Acid | 1 | 1 | 1 | 0.0085 | 0.0327 | 0.2111 |
| 46 | Sildenfil | 1 | 1 | 1 | 0.1049 | 0.0277 | 0.1406 |
| 47 | Sodium Borate | 1 | 1 | 1 | 0.0054 | 0.0568 | 0.0618 |
| | Decahydrate | | | | | | |
| 48 | Sodium Carbonate | 1 | 1 | 1 | 0.0001 | 0.0772 | 0.0915 |
| 49 | Sodium Sulfate | 1 | 1 | 1 | 0.0354 | 0.0023 | 0.3190 |
| 50 | Sodium Sulfite | 1 | 1 | 1 | 0.0129 | 0.0001 | 0.3655 |
| 51 | Sorbitol | 1 | 1 | 1 | 0.0550 | 0.0449 | 0.1178 |
| 52 | Splenda Sugar | 1 | 1 | 1 | 0.0057 | 0.0039 | 0.0093 |
| | Substitute | | | | | | |
| 53 | Strychnine | 1 | 1 | 1 | 0.0710 | 0.0660 | 0.2669 |
| 54 | Styrofoam | 1 | 1 | 1 | 0.0057 | 0.0036 | 0.0453 |
| 55 | Sucrose | 1 | 1 | 1 | 0.0125 | 0.0005 | 0.0128 |
| 56 | Sulfanilamide | 1 | 1 | 1 | 0.0547 | 0.0791 | 0.1330 |
| 57 | Sweet N Low | 1 | 1 | 1 | 0.0072 | 0.0080 | 0.0145 |
| 58 | Talc | 0 | 1 | 1 | 0.0000 | 0.0001 | 0.5381 |
| 59 | Tannic Acid | 1 | 1 | 1 | 0.0347 | 0.0659 | 0.0982 |
| 60 | Tide detergent | 1 | 1 | 1 | 0.0757 | 0.0078 | 0.2586 |
| 61 | Urea | 1 | 1 | 1 | 0.0001 | 0.0843 | 0.1892 |

FIG. 5A illustrates an exemplary flowchart of the present disclosure, the various steps of which are discussed in more detail with reference to FIGS. 5B and 5C below. Upon receiving a target spectral data set 501 (e.g., from a biological threat agent found in the field), the sensor diagnostic tests 502 may be initially performed simply as a confirmation from some or all of the sensor components (in the spectral data collection system in the field where the threat agent is encountered) that the sensor data were collected successfully. A number of different sensor components may be used. For example, one sensor component may be a Raman sensor, whereas another sensor component may be a near infrared sensor, fluorescence sensor, or a LIBS (laser induced breakdown spectroscopy) sensor, etc. If any sensor fails to perform according to its specifications, a service action 508 may be performed to rectify the error and prepare the sensor to operate normally and collect the corresponding spectral data (e.g., Raman, fluorescence, etc.) accurately.

A spectral data set that falls outside a library or reference data set beyond a predetermined confidence interval or tolerance (e.g., 95% match level threshold) may be considered as an outlier (discussed in more detail with reference to FIG. 5C below) so long as it is not simply a set of bad data (or a spectral “anomaly”). This “Initial Data Validation” test 503 is an optional test that is meant to only remove data that is “very bad.” In other words, the goal here may be to identify data that has no spectral peaks whatsoever. One possible way to do this would be to generate a histogram of the spectral intensities in the target data set. If the histogram is completely Gaussian, then that may mean that there are no spectral features in the target data set (i.e., the data set may be considered a “very bad” data set). Also, a simple signal-to-noise test can be applied here to validate the data. If the target data set is determined to be a “very bad” data set, then a retake operation 509 may be performed to obtain another set of target data. It may also mean that there is no spectral data present for that sample, in which case the sensor should move to the next sample 509. A simple test such as three iterations of data collection for a given sample without an acceptable signal-to-noise level could result in the sensor moving to the next sample.

Still referring to FIG. 5A, the Match Existing Class step 504 involves determining whether the target data set matches with any reference or known spectral data set. The results of this test can be reported in step 510. This test refers to FIG. 5B for details. The same set of steps (as in FIG. 5B) may be followed for the original models and for the noise-degraded models 505 as can be seen from the blocks in FIG. 5A. The results can be reported in step 511.

A number of methods may be used for determining class identification or target data classification (i.e., to determine with which class of reference spectra the target data may be associated, if any at all). There are many different methods that can be used for supervised classification. For example, the Mahalanobis Distance (MD) method may be used. The two factors to balance for supervised classification are sensitivity vs. overfitting. Consider the distribution of the set of points representing two classes (of reference spectra or spectral data set) in n-dimensional space. If there is significant overlap of the points for those two classes, that overlap can be removed by drawing classification boundaries that are specific to the points on the boundary. In other words, a jagged line enables more points to be classified correctly than a straight line does. Support Vector Machines (SVM) may allow this greater degree of discrimination, for example, than does MD. It may not be desirable to overfit on a particular training set with an accompanying loss of actual predictive power for spectra that were not included in the calibration set.

Reporting at step 510 or step 511 may include facts about the classification and the class to which the unknown (i.e., the target data set) was assigned. These may include things like the degree of confidence in the assignment, score associated with the match, whether the class was one of the original classes or a class that was generated via adaptive learning (as discussed later with reference to FIG. 5C), the degree of uniformity of the class as measured by the density, and the maximum leverage associated with any single point in the class (i.e., “outliers” in a given class).

The test (of the target data set) may be designed as a two-class problem—the threat class versus the background class. It could alternatively be designed as an n-class problem, where one may attempt to identify the particular class (biological species, chemical characterization of the explosive, etc). In some respects, the n-class problem may be easier than the 2-class problem because there may not be one big diverse class made up of the members of all the different threat classes. This may be the trade-off between one general model versus many smaller specific models. The smaller models may have more uniformly distributed members.

Data fusion (of data from different types of sensors such as, for example, a Raman sensor, a LIBS sensor, a fluorescence sensor, etc.) may take into account the confidence (specificity) associated with each spectroscopic method and the confidence associated with each class. In other words, if a given target is classified as belonging to a given class by a spectroscopic technique that has a high degree of specificity (such as Raman spectroscopy), then another technique that has a lower degree of specificity (such as fluorescence spectroscopy) may not override the classification unless the fluorescence class designation has a much higher degree of confidence than the Raman designation for the particular sample and class. The confidence associated with a class may depend on the degree to which the members of the class evenly and completely cover the space defined by the class—the homogeneity of the class. This can be measured by the density of the class in an n-dimensional space or in a reduced dimensional space. Other ways to measure the quality of the class may include the leverage exhibited by any single member of the class. In other words, if that single member is left out, does the space spanned by the class change drastically? If the change is drastic, then the quality of the class may be called into question. The quality of a match may be measured by how well the target spectrum fits inside the set of data points that define the class.

Note that using multiple target data points rather than a single target data point can greatly increase the confidence associated with a particular classification—e.g., by voting, polling. A plurality of measurements may likely be performed here, given the use of fiber optic bundles that provide multiple parallel measurements (e.g., in case of a fiber array translator (FAST) based spectroscopy unit). Using weighted confidence factors can also be helpful. The weights may be determined by grid search optimizations against ground truth (supervised classification). Thus, for example, a Raman measurement may likely have a higher weighting factor than a fluorescence measurement. This would be balanced against the quality of the match (score) for the one technique (e.g., Raman) vs. the other (e.g., fluorescence). In a similar fashion, a match from a class that is a very uniform class may be given more weight than a class that does not have a uniform distribution of the data points that define that class.

Note that weights could be continually updated as new members are added to the classes via the process defined in FIG. 5C.

It is noted here that any target data set not matching with the reference library data set within a predetermined confidence level/tolerance may be considered as representing “noise” data. However, as discussed herein, it may be desirable to further analyze this “noise” to identify whether a true outlier is present in the “noise.”

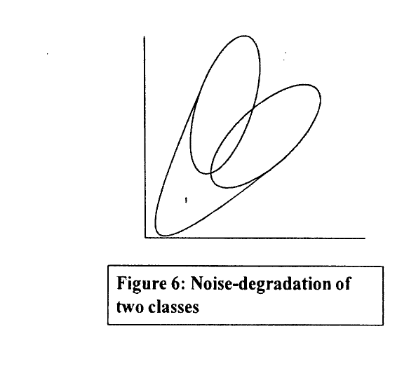

In FIG. 5A, the “Match Existing Noise-Degraded Class” test 505 also refers to FIG. 5B for details. Noise-degraded classes may be used because a classifier developed using high quality data may often have difficulty classifying lower quality test data. Retaining noise-degraded classes may afford the ability to classify lower-quality data, albeit with lower confidence. The notional region of two noise-degraded classes is shown as point 1 in FIG. 6. The process herein may use the same steps (FIG. 5B) as for the non noise-degraded classes. Noise-degraded classes may provide greater sensitivity and thereby allow unknown spectra to be classified that would not be classified by the classes that are not noise-degraded. A trade-off is that the noise-degraded classes may be much more likely to overlap and therefore it may be much more likely that the results of a classification may be inconclusive due to overlapping classes—i.e., less specificity. There is also the danger that noisy target spectra may be labeled as unknowns and added to the pool of unknowns 542 and ultimately to a new class 544. It may be desirable to check that excessively noisy target spectra are not considered as unknowns and added to new classes.

This Adaptive Learning Module 506 in FIG. 5A refers to FIG. 5C for details. FIG. 5C involves an exemplary process of adding unknown spectra to new classes. The process in FIG. 5C may be configured to learn weights to associate with multiple spectroscopic techniques (e.g., Raman, fluorescence, LIBS, etc.) used for data fusion. The idea of boosting may apply here; boosting may adaptively weight classifier members so as to turn weak learning classifiers into stronger classifiers. Boosting may be applied to the different classifiers to adaptively improve the system's target detection performance. The results of the process in step 506 (FIG. 5C) may be reported in step 507.

FIG. 5B illustrates an exemplary flowchart for a method of the present disclosure. A target data set is received in step 501 and then the step of Matching a Known Class 521 compares the target spectrum to each of the classes that are present in the spectral library. There are many methods that could be used such as, for example, the Mahalanobis Distance (MD), Partial Least Squares Regression (PLSR), Support Vector Machines (SVM), Linear Discriminant Analysis (LDA), Maximum Likelihood Estimation (MLE), Bayesian Classification, Neural Networks, Hidden Markov Models, or k-Nearest Neighbors. Several of the blocks in this flow chart (steps 528, 522, 526, 529) in FIG. 5B discuss the fusion of multiple data techniques. In these cases, a search (of the spectral library) may be performed for each technique and then fusion (of the target data sets) may be performed. There are other techniques that may require the fusion of the (target) data before the search is performed. These techniques may also be performed in this section of the flow chart rather than in the fusion sections. For example, there may be opportunities to do some searches (of the spectral library) where optical images are fused with spectroscopic images and both image and spectral properties are included as search parameters. Each classification technique may have certain statistics associated with it to constitute the thresholds by which a target sample is judged to be inside or outside a particular class.

If a match is not found, the next step may be to submit the (target) data to an unmixing step 522. Fusion may be performed along with unmixing in this case 522. It may be that data from auxiliary sensors may show a strong enough match to a given class to overrule the uncertainty associated with the match for the data from the dominant sensor. In one embodiment, the Raman sensor may function as the dominant sensor whereas other sensors (e.g., the LIBS sensor, or the fluorescence sensor, etc.) may be considered as auxiliary sensors. Successful results from fusion 522 may be reported in step 523. Failures can be reported in step 524.

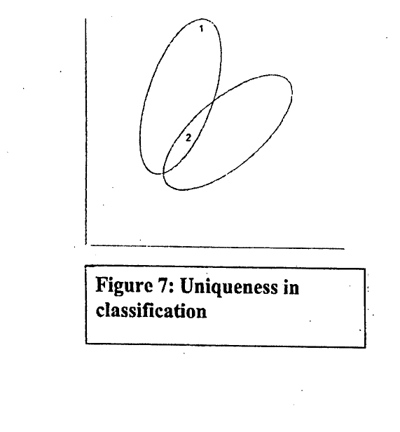

It is possible that classes may overlap for a small subspace in an n-dimensional space. A uniquely classified target spectrum is represented as point 1 in FIG. 7. If a given target spectrum falls into one of those subspaces where multiple classes overlap (illustrated as point 2 in FIG. 7), it may be statistically impossible to state to which of the overlapping classes the given sample belongs. Note that there may be certain fuzzy techniques that could state that one class is more likely than another class. In any event, the determination of whether or not the target data belongs to a unique class 525 tests whether the determination is confused or unique.

Still referring to FIG. 5B, if there are multiple data techniques available, they should be used to confirm 528 that data from auxiliary sensors give the same assignment as that from the dominant sensor. These results may be reported in step 531. As mentioned earlier with reference to discussion of FIG. 5A, less weight may be given to the data from auxiliary sensors and the proper weights should be found for each class for each type of sensor. If the confirmation in step 528 is not successful, then unmixing with fusion step 529 can be performed. If this step is successful, the result can be reported in step 532. If this step is not successful, the failure is reported in step 530.

If the classification models were unable to assign the target sample to a given class with the proper degree of confidence, then fusion may be performed in step 526. Fusion may allow the polling of additional data techniques if they are available. It is possible that these additional techniques may have high enough degrees of confidence to result in a statistically significant assignment of the target sample to one of the given classes which may be reported in step 527. If fusion is not successful, then unmixing with fusion can be performed at step 529.

The target data set may be a pure data set or a spectral mixture of, for example, data from a combination of chemical and/or biological entities. Unmixing is attempted if none of the preceding steps in FIG. 5B were successful. There are multiple methods that could be used for spectral unmixing, such as, for example, Target Factor Analysis, Spectral Mixture Resolution (SMR), Vector Component Analysis (VCA), Independent Component Analysis (ICA), as well as the family of least squares (LS) operators. In one embodiment, unmixing (of the target data set) can be performed for each data technique individually and fusion can then be performed. If all techniques find the same set of components in the (target) mixture, then there is a much higher degree of confidence than if just one technique finds a given set of components in the mixture. One should consider the fact that a target sample could be a mixture of compounds in one or more classes that are in the library and one or more compounds that are not present as a class. This is a true possibility, but one must also be aware that it is very easy to generate a linear combination of traces of knowns and potential unknowns that meet the numerical criteria (of classification) but that are not correct components of the target mixture.

The Adaptive Learning box 506, shown in FIG. 5A, refers to FIG. 5C. FIG. 5C illustrates an exemplary flowchart of various steps carried out by the Adaptive Learning Module 506 in FIG. 5A mentioned hereinbefore. More particularly, FIG. 5C illustrates a method for the detection of outliers and spectral library augmentation. A target data set is received in step 501. The determination of whether or not an outlier is present in the target data in step 541 is only reached if the classification algorithms were unable to assign the target data to either an individual class or as a mixture of multiple classes. Step 541 in the flow chart in FIG. 5C represents an initial test, such as the RX (Reed-Xu) algorithm, that tests whether a given (target) spectrum lies in the general space represented by at least one of the candidate classes. The RX algorithm, effectively, is the inverse of PCA (Principal Component Analysis). In the RX algorithm, anomalies are by definition rare or unusual events, and RX effectively examines the smallest eigenvalues to find these rare events. Other anomaly detectors can be substituted here, but the RX is a common and well-characterized method.

Still referring to FIG. 5C, if the initial test 541 (for anomaly detection) shows that the unknown target likely belongs to one of the candidate classes (i.e., the target doesn't appear to be an outlier) then the Match Existing Candidate Class step is performed at step 547. At this point, the process in FIG. 5B may be called to operate on the set of candidate classes.

If the matching steps (i.e., the process in FIG. 5B) result in a successful match, then the unknown (target) sample may be added to the given candidate class at step 548, and the model parameters for the class may be recomputed. This step should preferably include the assignment and storage of all relevant pieces of meta-data.

It is observed here that the addition of a data point to a candidate class 548 could affect other candidate classes. The now-bigger candidate class (because of the addition of the data point) could overlap with another class and cause a member of a different class to be reassigned. All candidate classes and even labeled classes may be reviewed to see how the changing class structure affects all other classes. If adaptive weights are used, the weights may need to be recalculated at this point. This is a computationally intensive step that may need to occur in the background (and, hence, is not expressly illustrated in FIG. 5C). The adaptive learning should preferably take all spectroscopic techniques into account for a given class—not just one technique.

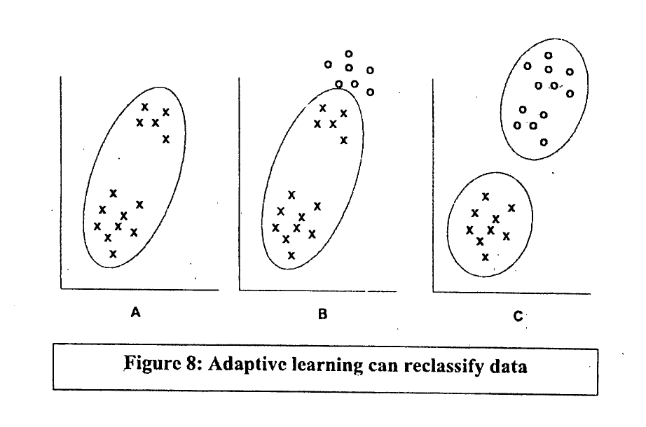

For illustration, FIG. 8 shows an original class (points shown by “x”) in subplot A, with a new candidate class (points shown by “o”) appearing in subplot B. The adaptive learning process may result in some members of the first class being reclassified into the new second class as shown by the subplot C.

In further reference to FIG. 5C, there may be a series of steps and tests 549 that must be performed and passed for a given candidate class to be elevated to the status of a labeled class and added to a list of existing classes at step 550. Results of confirmation 549 can be reported in step 552. A candidate class here is a collection of (spectral data) points not yet labeled, but that collection of points exhibits properties of a new class. However, the points may not yet pass all the criteria needed to confirm a new class. For instance, criteria such as the number of points, proximity or size of the candidate class, density, or class shape may be used to define a class. Hence, this step may include or require input from the user/expert. For example, a user/expert may need to take the target sample away from its field location for additional testing (using different test methods) in, for example, a laboratory. This input from the user could affect the composition of all candidate and labeled classes. It may be desirable to make provision for the fact that current input from the user may conflict with prior input from the user. Furthermore, it may be also desirable to add “fault tolerant” capabilities in this classification approach. It may also be possible that a user/customer may give different class labels to members of the same candidate class or labeled class.

If the candidate class is confirmed (in step 549 discussed above), this class may be added to the list of labeled classes 550. These results can be reported in step 551. Labeled classes can then be used for assignment in the top half of the flow chart in FIG. 5C (e.g., in the “Match Existing Candidate Class” step 547)—just like other classes that were developed explicitly (e.g., from data from known samples). There may be lesser degrees of confidence associated with these classes and the degree of confidence may improve as more data points are added to the labeled class and its statistics improves.

Still referring to FIG. 5C, if the target data is deemed to be a true outlier in step 541 (i.e., it does not belong to one of the candidate classes), then that target data may be assigned to the pool of unassigned data 542. A new entry in the pool of unassigned data may result in the clustering of enough data points in a particular region of the n-dimensional space to establish a new candidate class at step 543. Unassigned points falling outside all candidate classes may be reported as such 546 and remain unlabeled. Unsupervised clustering may be used to group the unlabeled points into potential candidate classes at step 543. If the clustering of enough data points in a particular region of the n-dimensional space demonstrated the ability to create a new candidate class, then the candidate class may be created 544 and the result may be reported at step 545. Hence, the outlier may be assigned a candidate class as noted above. Thereafter, future target data sets may be matched against the recently-established outlier class to determine whether there are any “hits” to the class. In one embodiment, after a pre-determined number of “hits” are received, the software may alert a human operator to get an actual, physical sample of the target generating the “hits” in order to analyze the sample in a laboratory to determine identity of the target and to ascertain whether the target sample is a new threat agent or something else.

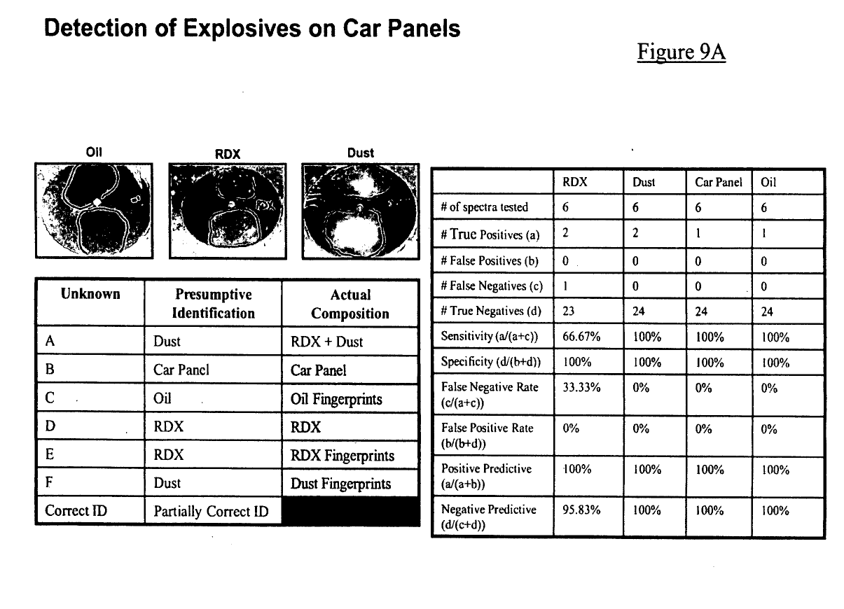

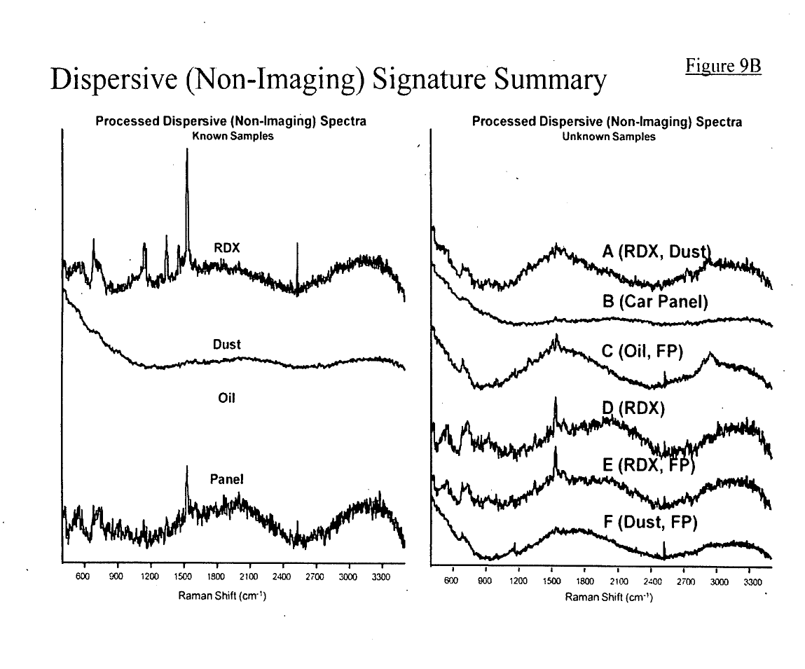

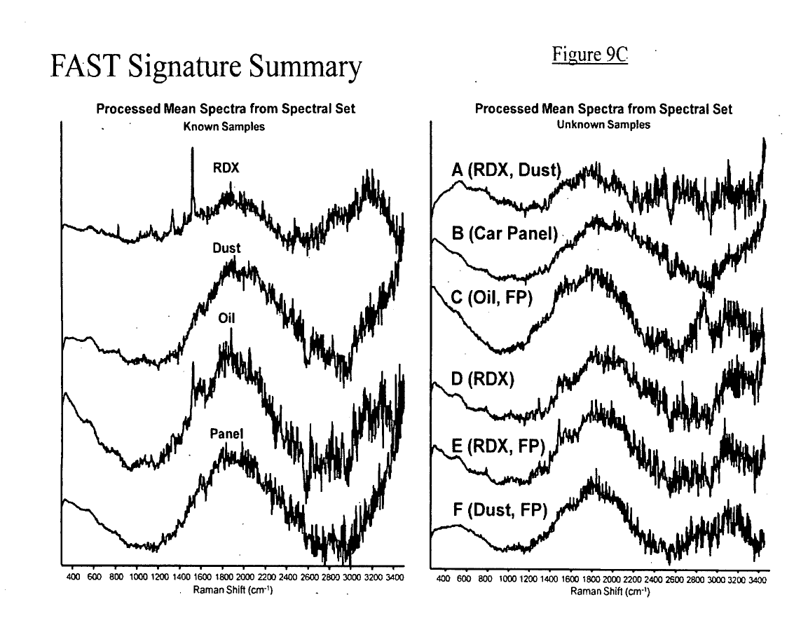

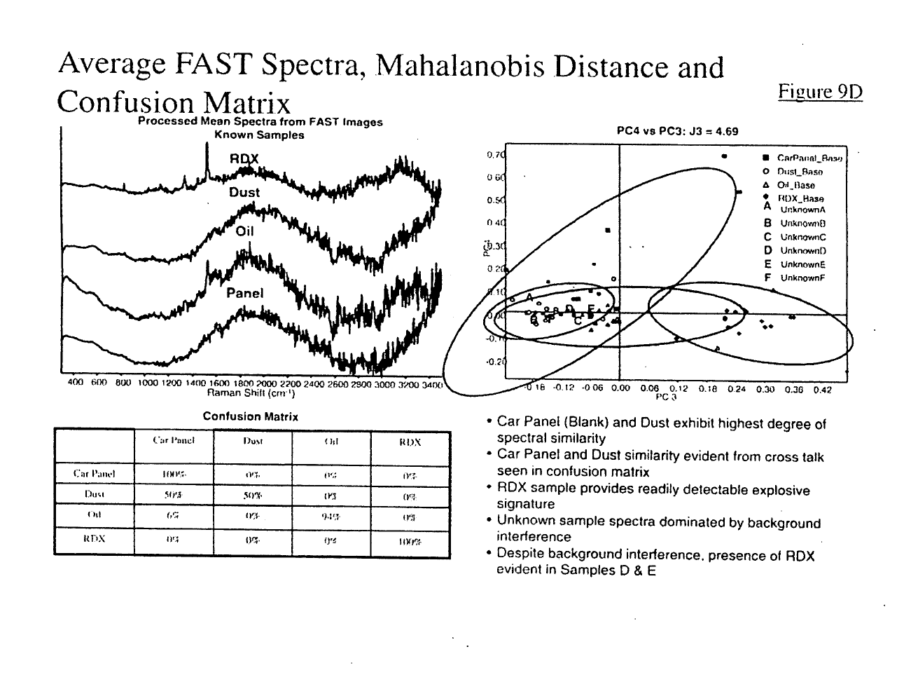

The Figures numbered 9A through 9D illustrate an exemplary set of test results to which the methodology described hereinbefore regarding detection of outliers and augmentation of spectral libraries may be applicable. FIG. 9A illustrates results of an exemplary test to detect explosives on car panels. A reference library was used to contain Raman data (spectra) of four known samples—RDX, road dust, oil, and a blank car panel. There were six sets of Raman spectra collected for six “unknown” samples to be identified—(i) sample-A contained a mixture of RDX and dust, (ii) sample-B was just the car panel (i.e., pure spectral data set), (iii) sample-C contained a mixture of oil and fingerprint oil (a confusant added to the blind samples to test for level of system accuracy), (iv) sample-D contained just the RDX, (v) sample-E was a mixture of RDX and fingerprint oil, and (vi) sample F contained a mixture of dust and fingerprint oil. Hence, each unknown sample was either an interference-dominated version of the known sample or a combination of two known samples, or a mixture of the known sample with a confusant. The spectra of test samples (the “unknowns”) were taken using a fiber array spectral translator (FAST)-based spectroscopy system employing a dispersive (non-imaging) spectrometer. It is seen from FIG. 9A that except for sample-A, all other unknown samples were identified correctly by the system during the test.

The average spectra of the known and unknown samples are shown in FIG. 9B, whereas the corresponding mean spectra are shown in FIG. 9C. FIG. 9D illustrates a scatter plot of principal component analysis of Raman spectral data of six test samples using MD (Mahalanobis Distance). A confusion matrix for the known (reference) samples is also provided in FIG. 9D.

It is seen from the scatter plot in FIG. 9D that the unknown sample-A had dust as the dominant component even if it also contained a small amount of the chemical threat agent RDX. Therefore, to more accurately detect such small (trace) amount of threat components amid other “interfering” components, it may be desirable to apply the earlier described outlier detection methodology to identify true outliers in the test data set and then assign appropriate class to the outliers so identified. Noise-degradation, adaptive learning, and fusion-based analysis discussed hereinbefore with reference to FIGS. 5A and 5C may be additionally carried out for samples such as sample-A to further assess their constituents more accurately and, hence, to “fine tune” the identification of threat agents present in the sample mixture.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the embodiments of the disclosure, it is noted that other variations and modification will be apparent to those skilled in the art, and may be made without departing from the spirit or scope of the disclosure.

What is claimed is:

1. A method for analyzing data from an unknown substance, comprising the steps of:
(a) receiving first target data representative of said unknown substance from a first data gathering modality and second target data representation of said unknown substance from a second data gathering modality;
(b) comparing said first target data with reference data associated with one or more known substances to thereby determine one or more candidate substances;
(c) determining if said first target data is unique to one of said candidate substances:
(i) if unique, comparing said second target data with said reference data:
(A) if the comparison of said second target data with said reference data confirms the determination of uniqueness, identify said unknown substance;
(B) if the comparison of said second target data with said reference data does not confirm the determination of uniqueness, performing an unmixing process using said first and second target data and identifying said unknown substance if the unmixing process results in a confirmation of the determination of uniqueness;
(ii) if not unique, comparing said second target data with said reference data:
(A) if the comparison of said second target data with said reference data results in a determination of uniqueness, identify said unknown substance;
(B) if the comparison of said second target data with said reference data does not result in a determination of uniqueness, performing an unmixing process using said first and second target data and identifying said unknown substance if the unmixing process results in a confirmation of the determination of uniqueness;
(d) if the comparison of said first target data with said reference data does not result in determining one or more candidate substances, performing an unmixing process using said first and second target data and identifying said unknown substance if the unmixing process results in a determination of a candidate substance.

2. The method of claim 1 further comprising performing one or more sensor diagnostic tests.

3. The method of claim 2 wherein said sensor is selected from the group consisting of: a Raman sensor, a near infrared sensor, a fluorescence sensor or a laser induced breakdown spectroscopy sensor, and combinations thereof.

4. The method of claim 1 further comprising performing initial data validation.

5. The method of claim 1 wherein said first data gathering modality and said second data generating modality are instruments selected from the group consisting of: a Raman spectrometer, a mid-infrared spectrometer, an x-ray diffractometer, an energy dispersive x-ray analyzer, a mass spectrometer, a microscope, image generating instrument, chromatographic analyzer, charge-coupled detector, and combinations thereof.

6. The method of claim 1 wherein said comparing of step (b) is performed by at least one of the following: mahalanobis distance, partial least squares regression, support vector machines, linear discriminant analysis, maximum likelihood estimation, Bayesian classification, neutral networks, hidden markov models, or k-nearest neighbors.

7. The method of claim 1 wherein said unmixing is performed by at least one of the following: target factor analysis, spectral mixture resolution, vector component analysis, independent component analysis, or family of least squares operators.

8. The method of claim 1 wherein said reference data comprises noise-degraded data.

9. A method for analyzing data from an unknown substance, comprising the steps of:
(a) receiving target data representative of said unknown substance;
(b) determining from said target data whether said unknown substance is an outlier:
(i) if said unknown substance is determined to be an outlier, assigning said target data to a pre-existing first pool of data representing one or more unidentified substances to thereby form a second pool of data;
(ii) analyzing said second pool of data to determine if a subgroup of said second pool of data represents a candidate substance; and
(iii) identifying said subgroup of data as said candidate substance; and
(c) if said unknown substance is determined to not be an outlier, comparing said target data with reference data associated with one or more candidate substances:
(i) if the comparison of said target data with said reference data does not result in matching said unknown substance with said one or more candidate substances, assigning said target data to said pre-existing first pool of data;
(ii) if the comparison of said target data with said reference data results in matching said unknown substance with a first candidate substance:
(A) adding said target data to said reference data associated with said first candidate substance;
(B) analyzing second target data to thereby confirm said candidate substance as a known substance; and
(C) adding said candidate substance to a pre-existing list of known substances.

10. The method of claim 9 wherein said target data is received from an instrument selected from the group consisting of: a Raman spectrometer, a mid-infrared spectrometer, an x-ray diffractometer, an energy dispersive x-ray analyzer, a mass spectrometer, a microscope, image generating instrument, chromatographic analyzer, charge-coupled detector, and combinations thereof.

11. The method of claim 9 wherein a Reed-Xu algorithm is used in step (b) to determine if said unknown substance is an outlier.

12. The method of claim 9 wherein said comparing of step (c) is performed by at least one of the following: mahalanobis distance, partial least squares regression, support vector machines, linear discriminant analysis, maximum likelihood estimation, Bayesian classification, neutral networks, hidden markov models, or k-nearest neighbors.

13. The method of claim 9 wherein step (c) further comprises the steps of:
(a) determining one or more candidate substances from said comparison;
(b) determining if said first target data is unique to one of said candidate substances;
(i) if unique, comparing said second target data with said reference data:
(A) if the comparison of said second target data with said reference data confirms the determination of uniqueness, identify said unknown substance;
(B) if the comparison of said second target data with said reference data does not confirm the determination of uniqueness, performing an unmixing process using said first and second target data and identifying said unknown substance if the unmixing process results in a confirmation of the determination of uniqueness;
(ii) if not unique, comparing said second target data with said reference data:
(A) if the comparison of said second target data with said reference data results in a determination of uniqueness, identify said unknown substance;
(B) if the comparison of said second target data with said reference data does not result in a determination of uniqueness, performing an unmixing process using said first and second target data and identifying said unknown substance if the unmixing process results in a confirmation of the determination of uniqueness.

14. The method of claim 13 wherein said comparing is performed by at least one of the following: mahalanobis distance, partial least squares regression, support vector machines, linear discriminant analysis, maximum likelihood estimation, Bayesian classification, neutral networks, hidden markov models, or k-nearest neighbors.

15. The method of claim 13 wherein said unmixing is performed by at least one of the following: target factor analysis, spectral mixture resolution, vector component analysis, independent component analysis, or family of least squares operators.
